(19) United States
(12) Patent Application Publication
(10) Pub. No.: US 2012/0273646 A1
(43) Pub. Date: Nov. 1, 2012

(54) Multi Dimensional Card Holder

(76) Inventor: John Forsythe, (US)

(21) Appl. No.: 13/095,809

(22) Filed: Apr. 27, 2011

(51) Int. Cl. A47G 1/16; B23P 11/00; F16M 13/00

(52) U.S. Cl. 248/466; 248/346.5; 29/428

(57) ABSTRACT

In view of the foregoing disadvantages inherent in the known types of card display devices present in the prior art, the present invention provides improved function and versatility. The present invention provides a multi dimensional card holder for greeting cards, picture cards and the like. Herein lies a device that allows for said cards, oriented however wished (vertically and horizontally) to stand on their own and not fall over when faced with a passing breeze/rush of air or if placed on a slippery surface. The present invention allows for the display of traditional two sided greeting cards (vertical and horizontal) preventing them from falling over and the display of single piece photo cards removing the need for tape/adhesives be stuck to the card. In addition the present invention allows for a) placement of said cards in areas where surface space may not have previously been sufficient but now will be based on the design of said device requiring a small footprint (less than a nickel) while providing a strong hold of display items and b) for placement of cards on areas that comprise not only strictly flat horizontal surfaces, but also on areas with sloping surfaces if the need arises.

### BACKGROUND OF THE INVENTION

1. Field of the Invention

The present invention relates generally to the field of display devices for viewing visual articles.

2. Description of the Related Art

The use of card display devices is known generally in the prior art. More specifically card display devices can be found to display cards in a multitude of manners such as organized into various patterns such as wreath or Christmas trees and hung on the wall, strings to hang cards and other familiar, obvious structural configurations.

By way of example, U.S. Pat. No. 5,531,038 to Keith discloses a five sided block to be inserted between the pages of a card.

U.S. Pat. No. 7,527,235, B2 to Hummel discloses a separate flat structure that a card would stand on.

US Pat Application NO 20110084183 to Jaewook discloses a structure with a base unit and seperate holding ribs.

U.S. Pat. No. 5,335,796 to Sanford discloses a device of tubular shape to display multiple cards affixed to various rods within the device.

Additional prior art may include U.S. Pat. Nos. 6,227,504 to Seaberg, 6,745,989 to Domasin, Design patent Des. 273,961 to Bassey and Design patent D545,095 to Lomas.

### BRIEF SUMMARY OF THE INVENTION

The multi dimensional card holder according to this present invention substantially departs from the conventional concepts and designs of prior art and in doing so provides an apparatus which will allow for the display of 2 sided cards in vertical and horizontal orientations (at whatever open angle user requires) and will also allow for the display of single sided photograph greeting cards. The design of said invention allows for users to display items in any conceivable orientation because the display device is small and therefore can allow for display items with multiple portions to have those portions be close together or far apart while still providing strong display support. It will be noted that greeting cards and the like are used throughout this application, however, it will be apparent to those skilled in the art that the invention contemplates the display of numerous items that may be referenced as a “display article(s)” generally. This may include cards, photographs and the like, but also includes anything that the user wishes to display. Further, the present invention design requires minimal display surface space and lends itself to reasonably contained manufacturing costs thereby making large numbers available to users to display large numbers of cards at a reasonable cost. Therefore it can be appreciated that there exists a continued need for a new and improved device for displaying cards.

### BRIEF DESCRIPTION OF THE SEVERAL VIEWS OF THE DRAWINGS

These and other features, aspects and advantages of the present invention will become better understood with reference to the following description, appended claims and accompanying drawings where:

FIG. 1. is a top and side view of present invention.

FIGS. 2, 3 and 4 are examples of how present invention could be used as a multidimensional card holder.

### DETAILED DESCRIPTION OF THE INVENTION

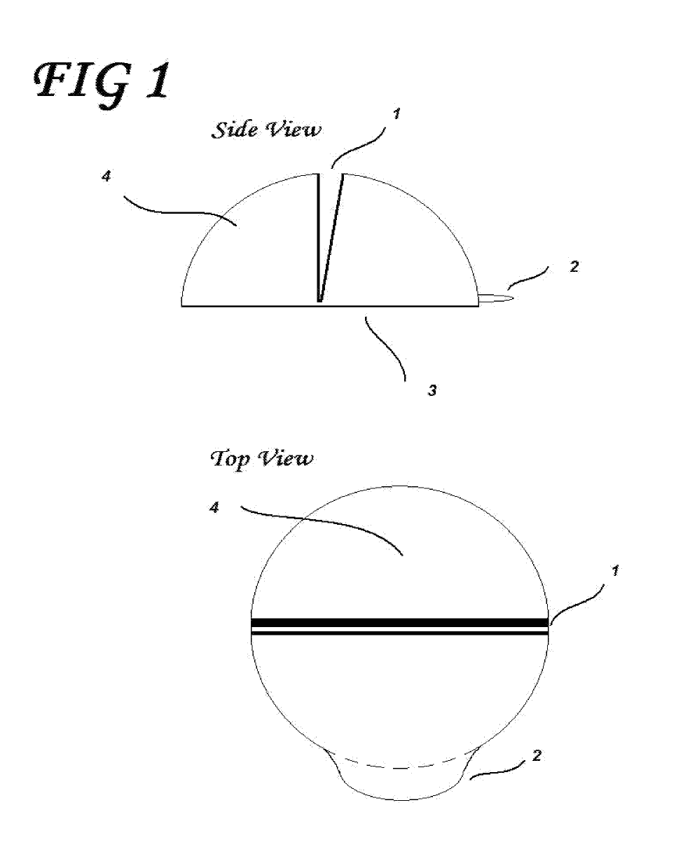

The present invention whose main purpose is as a holder of items, such as greeting cards, to be displayed on a surface has a number of distinct features. FIG. 1, 1 shows one embodiment of the present invention, displaying a slot that comprises an entrance angle for that which is being displayed. The entrance angle may comprise various angle measurements and may be utilized at different locations within the holder yet remain within the scope of the invention. The entrance angle, as will be clear to those skilled in the art, relates to the portion defined within the device that allows for insertion of a desired display article. This may be referred to generally as a slot, and may be of varying depths in addition to placement within the device. The slot may also resemble a lip or the like in that one wall that defines the slot may be of a different size than one or more other walls, and may or may not transverse the device in its entirety. Additionally, the slot need not be uniform in any direction, and also need not be completely linear in shape, although it may be, as desired. As noted, the body of the display device has a shape that forms an intrinsic slot. This slot is designed intentionally to dissipate any forces applied to display items that might normally knock the display item over. Additionally the slot will hold display items based on its angle and placement within the body. The slot itself will have smooth surfaces such that items can be displayed without deformation or other physical change. The present invention, in another embodiment, may include a single component or a plurality of components displaying either a single display article or even a plurality of display articles together. A single component could be used, for example for a display article that comprises a single sheet of cardstock or the like, or in the case of card that has been folded in two parts, two or more components could be utilized with each portion of the display article. It will be clear to those skilled in the art that numerous configurations and numbers of components may be utilized without departing from the scope of the invention. In a preferred embodiment, the front of the present invention is shown to include a multi-purposed ‘lip’ 2, which may act as a designator of a preferred orientation and as a way to lift the holder from the surface it is placed on or for removing from the original packaging. The present invention could be used without the lip, but in a preferred embodiment the lip is advantageous for the reasons mentioned previously. The bottom 3 of a preferred embodiment of the present invention is also shown. It may be flat and/or adorned with adhesive which will be sufficiently strong enough to hold device and that which it is displaying in place. The adhesive, if used, will allow for removing from display area after use and replacing invention back into original packaging for use at another time as desired. The bottom of the display device can either be flat to work in conjunction with adhesive thus creating the needed anchoring of the display device or may be concave to allow for anchoring the display device through the use of suction between the display device and the surface on which the display device bottom is affixed. The body 4 of the display device may be composed of a plastic/rubber material, or similar material, which will allow for durability and elasticity which helps absorb forces applied to display items placed within the display device and may be shaped and/or colored in a manner consistent with the overall intent to not distract from the appearance of that which it is displaying. The shape and color, if any, may also be chosen to provide a communication with the overall theme of not only the display item, but also the area in which the device is utilized, thereby providing an overall aesthetic as desired by the user.

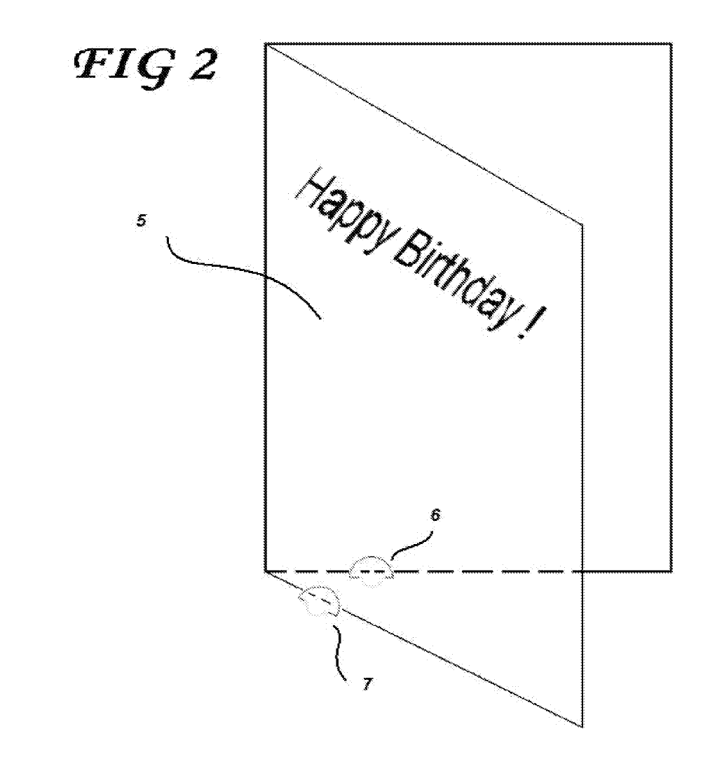

FIG. 2 displays a preferred embodiment of the present invention showing a two sided greeting card, 5, being displayed in a vertical orientation. The multidimensional card holder is shown comprising a first component 6 and a second component 7 facing towards the front of the card with the card slid into the slot 1. The lip 2 of the device is shown in first and second components 6 and 7 as well. The bottom 3 of the device is affixed (temporarily in this embodiment) to the surface that was chosen as the site of display. It will be noted that in this embodiment the present invention comprises more than one component working in concert. Any number of components may be utilized as desired.

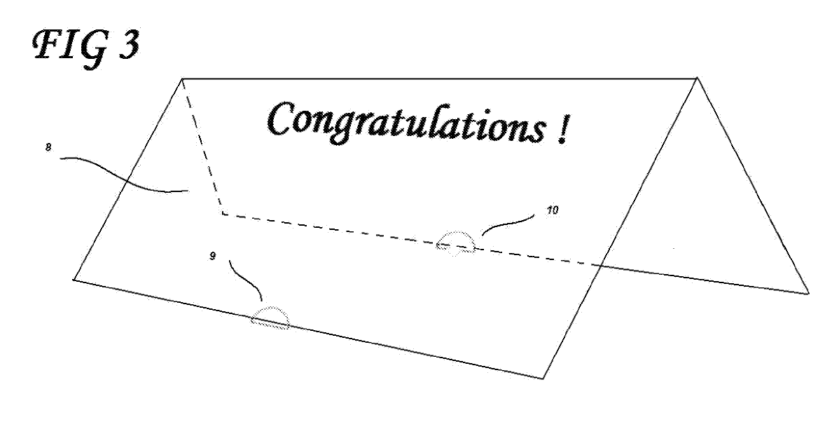

FIG. 3 displays another preferred embodiment of the present invention, showing a two sided greeting card, 8, being displayed in a horizontal orientation. The multidimensional card holder is shown comprising a first component 9 and second component 10 with the front of the card (the side with the lip 2 in this embodiment) facing each other. The card, 8, again is slid into the slot 1 of the device. The bottom 3 of the device is again affixed (temporarily) to the surface that was chosen as the site of display.

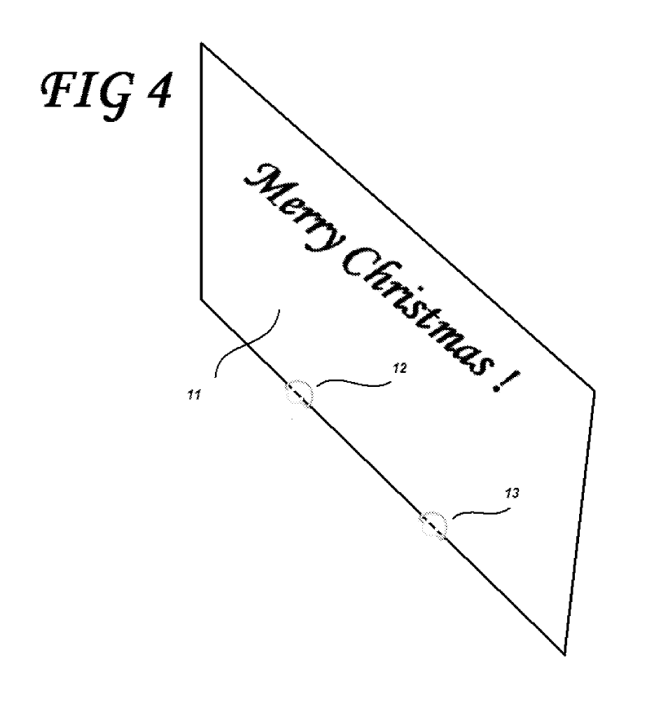

FIG. 4 shows another embodiment of the present invention displaying a single sided greeting card, 11, being displayed by present invention first and second components 12 and 13 thereby removing the need to lean the card on something or be taped to something.

It will be apparent to those skilled in the art that various changes may be made to material and shape without departing from the scope of the present invention. For example, the shape of the device may comprise a more square, rectangular, triangular, or any other geometric or non-geometric shape. The device, when used in a multiple component fashion, may comprise similar or different shapes in each of the components. As previously mentioned, the color scheme may be neutral or include colors designed to either match or contrast with either of the display items or other surroundings in any manner. A variety of scents could also be employed with the device, either integrally or as part of the adhesive or other means. The device itself may further comprise objects, pictures or designs within the body of the device itself or on its surface as well. The device could also include any other surface decoration and remain within the scope of the invention.

What is claimed is:

1. A multi dimensional display system for holding a display item upon a display surface in any configuration or orientation desired, said display system comprising at least a first display device, wherein said first display device comprises a body, wherein said body further comprises an entrance slot formed within said body, said entrance slot further comprising an entrance angle, and wherein said entrance slot is configured to receive said display item, and wherein said display device further comprises a bottom surface.

2. The display system of claim 1, wherein said entrance angle assists with retaining said display item within said display device.

3. The display system of claim 2, further comprising a second display device.

4. The display system of claim 3, further comprising a third display device.

5. The display system of claim 2, wherein said bottom surface further comprises an adhesive material.

6. The display system of claim 2, wherein said entrance angle is between zero and ninety degrees.

7. The display system of claim 6, wherein said display device further comprises a lip, wherein said lip extends from a point where said body and said bottom surface meet.

8. The display system of claim 2, wherein said display device is substantially formed from a rubber material, wherein said rubber material further comprises a device friction, and wherein said rubber material further comprises a device elasticity and wherein said device friction assists with retaining said display item within said display device, and wherein said device elasticity assists with retaining said display item within said display device.

9. The display system of claim 8 further comprising a display theme, wherein said display theme communicates with said display item.

10. The display system of claim 2, wherein said entrance slot comprises two entrance surfaces and wherein said entrance surfaces are substantially flat whereby said display item may be removed from said display device without noticeable deformation or other physical change.

11. The display system of claim 2, wherein said display item comprises at least one greeting card.

12. The display system of claim 2, wherein said display item comprises at least one photocard.

13. The display system of claim 2, wherein said display item comprises at least one sales description card.

14. The display system of claim 2, wherein said display item comprises at least one photograph.

15. The display system of claim 7, wherein a display surface comprises a substantially non-horizontal surface.

16. The display system of claim 4, wherein said display item comprises a first portion and a second portion, and wherein said first display device communicates with said first portion and said second display device communicates with said second portion.

17. A multi dimensional display system for holding a display item upon a display surface in any configuration or orientation desired, said display system comprising at least a first display device, wherein said first display device comprises a body, wherein said body further comprises an entrance slot formed within said body, said entrance slot further comprising an entrance angle, and wherein said entrance slot is configured to receive said display item, and wherein said display device further comprises a bottom surface, and wherein said bottom surface further comprises an adhesive material, and wherein said display device further comprises a lip, wherein said lip extends from a point where said body and said bottom surface meet.

18. The display system of claim 17, wherein said body further comprises a body diameter, said body diameter measuring no greater than twenty millimeters.

19. A method for displaying a display item upon a display surface, comprising the steps of:
providing at least one display device, wherein said display device comprises a body, wherein said body further comprises portions defining an entrance slot, said entrance slot configured to receive said display item, and wherein said display device further comprises a bottom surface;
placing said display device on said display surface;
inserting said display item substantially within said body.

20. The method of claim 19, wherein said display item comprises a bi-fold card, wherein said bi-fold card further comprises a first portion and a second portion, and wherein said step of providing at least one display device further comprises providing two display devices, and wherein said step of inserting said display item substantially within said entrance slot further comprises inserting said first portion substantially within the entrance slot of said first display device and inserting said second portion substantially within the entrance slot of said second display device.
